(19) United States
(12) Patent Application Publication
(10) Pub. No.: US 2003/0052947 A1
(43) Pub. Date: Mar. 20, 2003

(54) Structure of an inkjet printhead chip and method for making the same

(76) Inventors: Chen-Hua Lin, Yunlin Hsien (TW); Ming-Hsun Yang, Taipei (TW)

Correspondence Address: BIRCH STEWART KOLASCH & BIRCH, PO BOX 747, FALLS CHURCH, VA, 22040-0747, US

(21) Appl. No.: 10/213,097

(22) Filed: Aug. 7, 2002

(30) Foreign Application Priority Data
Sep. 14, 2001 (TW) 90122817

(51) Int. Cl. B41J 2/05

(52) U.S. Cl. 347/63

(57) ABSTRACT

This specification discloses a structure of an inkjet printhead chip and the method for making the same. A silicon substrate installed with a thermal element is covered with a photoresist layer or polymer material as a barrier layer. A sandblasting process is employed to make a slot on the silicon substrate as an ink channel. A photolithographic process is used to form a pattern on the barrier layer, which is then etched to form many ink cavities in fluid communications with the ink channel and pillars between the ink chambers. Finally, the barrier layer is attached onto a polymer nozzle plate by lamination. The pillars are formed between the ink cavities and the ink channel so that the polymer does not sink at the ink cavities or around the nozzles during lamination, thus ensuring the correction ejection direction of the nozzles.

### BACKGROUND OF THE INVENTION

1.Field of Invention

The invention relates to a structure of an inkjet printhead chip and the method for making the same. More particularly, the invention relates to a method that uses a polymer plate or a flexible printed circuit as the nozzle plate to form a printhead.

2. Related Art

Currently, the most popular inkjet chips are of two types: the thermal and the piezoelectric. Due to severe competition among the same kind of products, researchers have to make further progress so that the new inkjet chip has a structure that satisfy all requirements. Furthermore, the manufacturing process has to be devised so that the cost lowers while the yield increases. All these reply on breakthroughs in the designs of structure, manufacturing process, and materials. Taking as an example the U.S. Pat. No. 4,683,481, “Thermal Ink Jet Common-Slotted Ink Feed Printhead”, a silicon substrate is drilled with a central reservoir for transporting ink to common channels inside each ink cavity on the silicon substrate. The silicon substrate is covered with a piece of metal nozzle plate. The nozzles on the nozzle plate are aligned with the ink cavities on the silicon substrate. When the heater resistor in any one of the ink cavities is supplied with an electrical current, the ink around the resistor is rapidly heated and vaporized instantaneously to eject out of the metal nozzle.

The metal nozzle plate has a higher production cost and requires a complicated manufacturing process. It is thus highly desirable if one can combine the nozzle plate and the flexible printed circuit connecting to control signals together or replace the metal with polymers to lower the cost and simplify the manufacturing process. However, directly replacing the metal nozzle plate with a polymer layer or a flexible printed circuit has difficulty in the sinking of the flexible printed circuit during the final lamination process.

### SUMMARY OF THE INVENTION

An objective of the invention is to provide a structure of an inkjet printhead chip and the method for making the same, so that the sinking can be avoided during the lamination process. The disclosed inkjet printhead chip is comprised of a silicon substrate, a barrier layer, and a nozzle plate. The silicon substrate is formed with an ink channel, and its surface is installed with a plurality of thermal elements. The barrier layer covers atop the silicon substrate and has a plurality of ink cavities formed corresponding to the positions of the thermal elements. A plurality of pillars is formed between the ink cavities and the ink channel. The nozzle plate, which covers the barrier layer, is made of a polymer layer or a flexible printed circuit and has a plurality of nozzles formed corresponding to the thermal elements and the ink cavities. The nozzle plate is combined with the barrier layer using the lamination process. The pillars avoid the sinking of the polymer layer or the flexible printed circuit near the ink cavities due to the lamination process.

According to the invention, the method of making the above-mentioned inkjet printhead chip includes the following steps. A photoresist layer or polymer layer is covered on a silicon substrate installed with thermal elements as a barrier layer. A sandblasting process is employed to make a slot on the silicon substrate as an ink channel. A photolithographic process is used to form a pattern on the barrier layer, which is then etched to form many ink cavities in fluid communications with the ink channel and pillars between the ink chambers. Finally, the barrier layer is attached onto a polymer nozzle plate or flexible printed circuit by lamination. Since the pillars are formed between the ink cavities and ink channel, they can support the polymer layer so that it does not sink during the lamination process. This maintains the correct ejection direction of the nozzles.

### BRIEF DESCRIPTION OF THE DRAWINGS

FIG. 1 is a schematic view showing a nozzle plate that directly uses a normal polymer or flexible printed circuit to replace the conventional metal plate.

FIG. 2 shows that the polymer or flexible printed circuit in FIG. 1 sinks during the lamination process, resulting in skewed ejection directions indicated by the arrows.

FIG. 3 is a schematic cross-sectional view of a printhead structure finished according to the disclosed method.

FIG. 4 shows the printhead structure formed according to the invention. Although the central portion of the polymer plate or flexible printed circuit also sinks slightly, the portions around the nozzles are not sinking or tilt. The ejection directions are therefore kept unchanged, as indicated by the arrows.

### DETAILED DESCRIPTION OF THE INVENTION

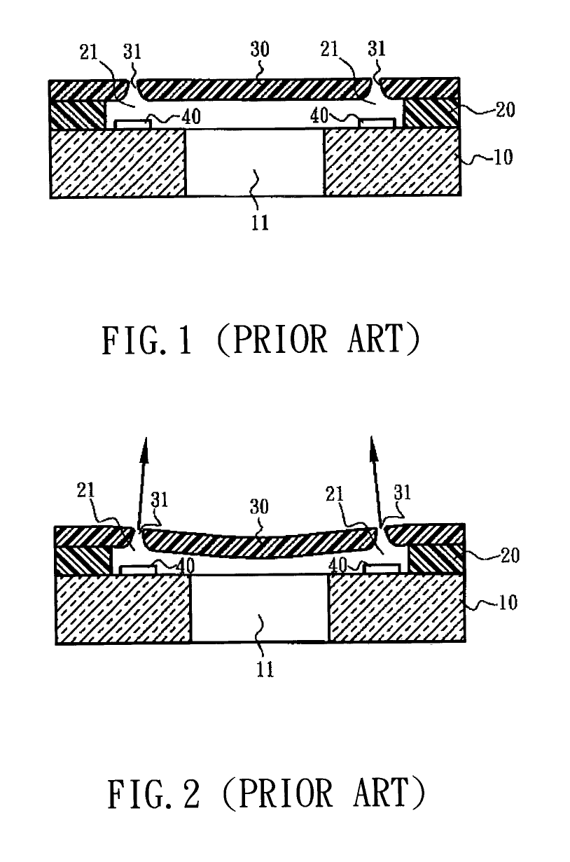

As shown in FIG. 1, if one simply uses a usual polymer plate or a flexible printed circuit 30 to substitute the usual metal nozzle plate, it may sink during the lamination process in step d (see FIG. 2). This will result in skewed ejection directions in the nozzles 31, as indicated by the arrows in the drawing. However, using the disclosed method to form pillars 22 between the ink cavity 21 on the barrier layer 20 and the ink channel, the pillars 22 can support the polymer plate and the flexible printed circuit 30 so that it does not sink around the ink cavity 21 during the lamination process in step d. The result is shown in FIG. 4. Although the central portion of the polymer plate or flexible printed circuit 30 may still sink slightly, there is no sinking or tilting around the nozzles 31 at all. This ensures that the ejection directions of the nozzles are along the arrows as desired.

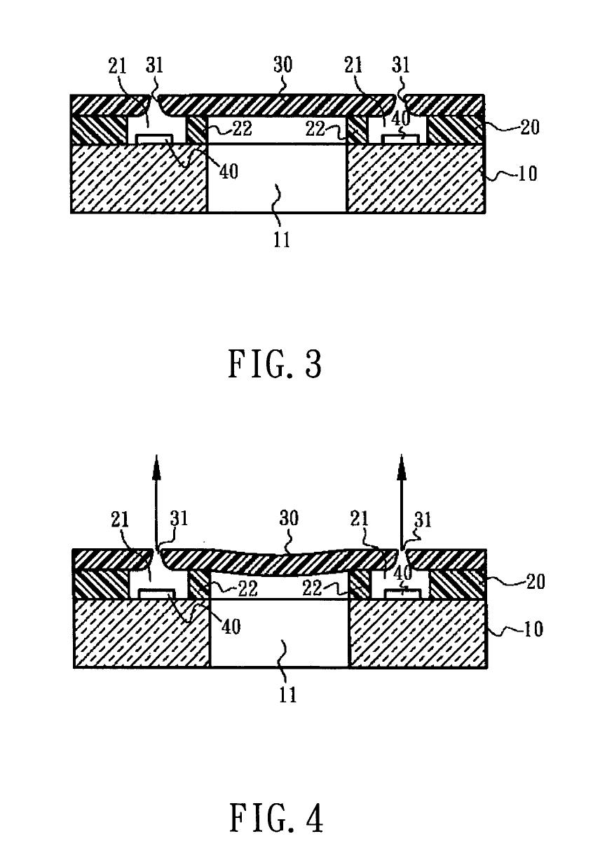

With reference to FIG. 3, the printhead structure includes a silicon substrate 10 installed with a plurality of thermal elements 40 and an ink channel 11 formed in the middle. A barrier layer 20 is formed on top of the silicon substrate 10 and has a plurality of ink cavities 21 and pillars 22. The barrier layer 20 is attached with a polymer plate or flexible printed circuit 30 with nozzles 31 to form a nozzle plate.

The method of the invention includes the following steps:

a. cover a barrier layer 20 on a silicon substrate 10 with thermal elements 40;

b. make a slot in the middle of the silicon substrate as an ink channel 11;

c. use a photolithographic process to form a pattern on the barrier layer 20 and etch the barrier layer 20 to form many ink cavities 21 connected to the ink channel 11 and pillars 22 by the ink cavities; and

d. pasting a polymer plate or flexible printed circuit 30 with nozzles 31 onto the barrier layer 20 using the lamination process to form a nozzle plate.

Before step a, one can first form a SiO₂ insulation layer on the surface of the silicon substrate 10. A photoresist material or a polymer plate is then applied over the surface of the silicon substrate 10 to form the barrier layer 20 as mentioned. In step b, the ink channel 11 can be made by first using lithography to form a mask and then using chemical etching and/or sandblasting to penetrate the silicon substrate 10, thus forming a slot as the ink channel 11. In step c, the height of the pillars 22 can be slightly higher than or equal to that of the barrier layer 20. The nozzles 31 in step d can be formed using laser ablation or the photoresist lithographic technique.

Certain variations would be apparent to those skilled in the art, which variations are considered within the spirit and scope of the claimed invention.

What is claimed is:

1. An inkjet printhead chip structure comprising:
a silicon substrate formed with an ink channel and a plurality of thermal elements on its surface;
a barrier layer covering the silicon substrate and having a plurality of ink cavities corresponding to the positions of the thermal elements, and provided with a plurality of pillars between the ink cavities and the ink channel; and
a nozzle plate covering the barrier layer and having a plurality of nozzles corresponding to the positions of the thermal elements and the ink cavities;
wherein the nozzle plate is made of a polymer plate and is combined with the barrier layer by lamination process, and the pillars prevent the polymer plate from sinking around the ink cavities due to the lamination process.

2. The inkjet printhead chip structure of claim 1, wherein the ink channel is made by first forming a mask on the silicon substrate surface and then using a chemical etching process to obtain the ink channel.

3. The inkjet printhead chip structure of claim 2, wherein the ink channel is made by using a chemical etching process along with sandblasting to penetrate through the silicon substrate.

4. The inkjet printhead chip structure of claim 2, wherein the mask is formed on the silicon substrate surface using lithography.

5. The inkjet printhead chip structure of claim 1, wherein the height of the pillar is equal to that of the barrier layer.

6. The inkjet printhead chip structure of claim 1, wherein the height of the pillar is higher than that of the barrier layer.

7. A method for making an inkjet printhead chip comprising the steps of:
a. making an ink channel in the middle of a silicon substrate with thermal elements;
b. covering a barrier layer on the silicon substrate;
c. using photolithography to form a pattern on the barrier layer and etching the barrier layer to obtain a plurality of ink cavities in fluid communications with the ink channel and pillars near the ink cavities; and
d. using a lamination process to combine a polymer plate with nozzles to form a nozzle plate.

8. The method of claim 7, wherein the ink channel is made by first forming a mask on the silicon substrate surface and then using a chemical etching process to obtain the ink channel.

9. The method of claim 8, wherein the chemical etching process is combined with sandblasting to penetrate through the silicon substrate, thus forming the ink channel.

10. The method of claim 8, wherein the mask is formed on the silicon substrate surface using lithography.

11. The method of claim 7, wherein the height of the pillar is equal to that of the barrier layer.

12. The method of claim 7, wherein the height of the pillar is higher than that of the barrier layer.
